(19) United States
(12) Patent Application Publication
(10) Pub. No.: US 2024/0119344 A1
(43) Pub. Date: Apr. 11, 2024

(54) SYSTEM AND METHOD FOR EXPEDITING DISTRIBUTED FEEDBACK FOR DEVELOPING OF MACHINE LEARNING CLASSIFIERS

(71) Applicant: Deere & Company, Moline, IL (US)

(72) Inventor: Mark J. Cherney, Bettendorf, IA (US)

(21) Appl. No.: 17/960,926

(22) Filed: Oct. 6, 2022

(51) Int. Cl. G06N 20/00; G06K 9/62; G06V 10/764

(52) U.S. Cl. CPC G06N 20/00; G06K 9/6256; G06V 10/764

(57) ABSTRACT

A system and method are provided for expediting distributed feedback for training of supervised learning models. A campaign may be initiated for development of a model for classifying at least a first type of subject, wherein notifications are generated to each of various potential feedback source devices (generally broadcast or to a selected sub-group) requesting responsive images comprising the least first type of subject. Respective feedback connections are established between each of the plurality of potential feedback source devices and a data storage network associated with the model. The method includes automatically tagging input messages comprising responsive images received via the feedback connection with source metadata and further as being in association with the notification, and correlating the images received via the respective feedback connections, as components of a first data set for the at least first model, with the at least first type of subject and tagged metadata.

### FIELD OF THE DISCLOSURE

The present disclosure relates generally to the development of machine learning classifiers, and more particularly to systems and methods for expediting distributed feedback for the development of such classifiers, still more particularly for the performance optimization of supervised learning models.

### BACKGROUND

Generally stated, supervised learning models are a subcategory of machine learning characterized at least by the implementation of classification algorithms that are trained over time using input data sets that are mapped or correlated with respect to labeled output data sets. The development of machine learning classifiers require a significant amount of data which must be collected in order to train the classifiers for performance optimization. In conventional applications this usually requires manual labeling of content such as images to provide ground truth for the training and test data sets.

One of the challenges for data collection and labeling is simply based on the resources required to collect enough useful data, e.g., images including desired content for training of a particular model, and to identify that desired content with enough confidence.

Another challenge is identifying necessary metadata such as for example lighting, weather, obstacle types, etc., associated with the data sets. The conventional need to manually identify or confirm such metadata post-facto can be particularly resource intensive.

### BRIEF SUMMARY

The current disclosure provides an enhancement to conventional systems, at least in part by introducing a novel system and method for expediting supervised learning model development by, e.g., initiating campaigns for user feedback regarding specified content and optionally with respect to specific metadata, such that a higher volume of data collection is hopefully provided and further that such data collection is already associated with the metadata that otherwise must be determined in a resource-intensive manner as discussed above.

Some metadata elements such as lighting and weather in association with a captured image can be automated to a certain extent through knowledge of the latitude/longitude along with the time of day, and further by reference to weather data. Another exemplary technique for metadata collection may include requesting feedback from a user at the time an image is collected. For example, if the machine learning classifier has low confidence in the initial identification of a car in a captured image, an associated system could direct a pop-up message to be displayed to a user associated with the image capture device, e.g., to confirm if the image indeed includes a car with a yes/no or multiple choice query. A response from the user can then be attached to the image in storage as metadata used for sorting and post-processing by, e.g., a cloud server application.

Another technique for facilitating data collection may be to provide incentives to users for submitting appropriate images for an input data set, particularly where the images include a desired content and in the context of specified metadata such as lighting and weather (e.g., images including cars in rain or snow).

By directing requests to specific users, for example users that are identified as being most likely to encounter the desired content and in the context of the specified metadata, and by effectively associating feedback from those specific users with a predefined campaign, a system and method as disclosed herein can comprise a low cost solution for collecting meaningful data sets for continuous improvement of supervised machine learning models.

In one embodiment, a method is disclosed of expediting distributed feedback for training of supervised learning models. The method includes, in association with development of at least a first model for classifying at least a first type of subject, generating notifications to each of a plurality of potential feedback source devices requesting responsive images comprising the least first type of subject. A respective feedback connection is established between each of the plurality of potential feedback source devices and a data storage network associated with the at least a first model, and input messages comprising responsive images received via the feedback connection are automatically tagged with source metadata and further as being in association with the notification. The images received via the respective feedback connections are correlated, as components of a first data set for the at least first model, with the at least first type of subject and tagged metadata.

In one exemplary aspect according to the above-referenced method embodiment, at least a first campaign may be initiated for development of the at least first model, wherein the images received via the respective feedback connections in association with the at least first campaign are correlated with the at least first type of subject and tagged source metadata comprising at least one of the one or more defined classifying conditions.

In another exemplary aspect according to the above-referenced method embodiment, notifications may be broadcast in accordance with the first campaign to a network of available feedback source devices comprising each of the plurality of potential feedback source devices, wherein the broadcast notifications including a request for images comprising the at least first type of subject under the at least one of the one or more defined classifying conditions.

In another exemplary aspect according to the above-referenced method embodiment, each of the plurality of potential feedback source devices may be selected from a network of available feedback source devices based on, e.g., identified lighting and/or weather conditions associated with each of the network of available feedback source devices as corresponding to the at least one of the one or more defined classifying conditions.

In another exemplary aspect according to the above-referenced method embodiment, the lighting and/or weather conditions associated with each of the network of available feedback source devices may be identified by reference to respective position data with respect to a time of day and/or determined weather conditions.

In another exemplary aspect according to the above-referenced method embodiment, the respective weather conditions for each of the network of available feedback source devices may be determined via one or more third party weather applications and/or databases.

In another exemplary aspect according to the above-referenced method embodiment, images received via the feedback connection may be automatically verified as relating to the at least first type of subject, based at least in part on the source metadata and the corresponding notification, wherein only verified images are correlated in the data storage, as components of the first data set for the at least first model, with the at least first type of subject and the tagged metadata.

In another exemplary aspect according to the above-referenced method embodiment, the plurality of potential feedback source devices each comprise an onboard display unit, a user interface, and one or more image sensors, wherein user engagement of at least one specified portion of the user interface responsive to the generated notification may cause an image to be captured by at least one of the one or more image sensors and then transmitted via the respective feedback link.

In another exemplary aspect according to the above-referenced method embodiment, the tagged source metadata for each image may comprise a type of image sensor capturing the image, and/or a location of the feedback source device, and/or a data and time at which the image is captured.

In another embodiment as disclosed herein, a system for expediting distributed feedback for training of supervised learning models may include a computing network, for example comprising one or more servers in functional communication with a plurality of potential feedback source devices. The computing network is configured, in association with development of at least a first model for classifying at least a first type of subject, to direct the performance of steps according to the above-referenced method embodiment and optionally any of the further described exemplary aspects.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a block diagram representing an exemplary embodiment of a system according to the present disclosure.

FIG. 2 is a flowchart representing an exemplary embodiment of a method according to the present disclosure.

FIG. 3 is a flowchart representing an exemplary sub-process for feedback source selection according to the method of FIG. 2.

### DETAILED DESCRIPTION

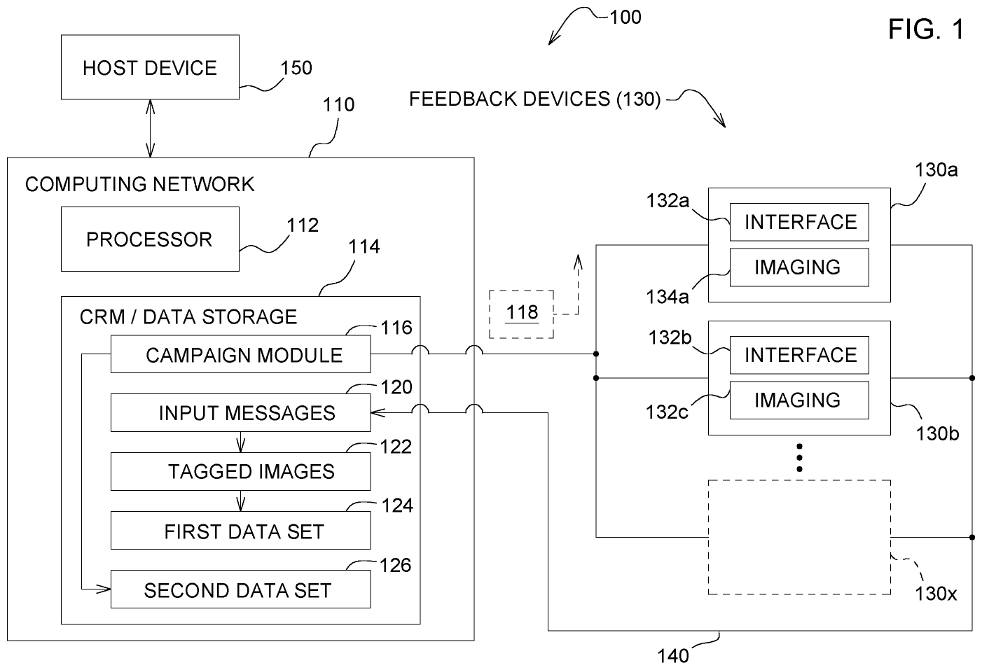

An exemplary embodiment of a system 100 according to the present disclosure may now be described with illustrative reference to FIG. 1. A computing network 110 may take the form a single computing device configured to execute functions as further described herein, or may comprise a plurality of computing devices. Feedback devices 130 are functionally linked to the central computing network 110 and may typically take the form of a mobile computing device such as a cell phone or an onboard device associated with a vehicle such as a work machine. One or more host devices 150 may further be functionally linked to the central computing network 110, for example to initiate campaigns or otherwise modify campaign settings according to the present disclosure.

Although not shown, the system 100 may include a first user interface associated with the computing network 110 by which the various feedback devices 130 associated with potential feedback sources may access or otherwise exchange communications with the computing network 110, wherein potential feedback sources in this context may refer to individuals, machines (e.g., vehicles having requisite onboard capabilities), and/or organizations that are known to the system. In an embodiment, each potential feedback source may for example be participants in an exchange operated or otherwise administered via the system 100, wherein incentives may be offered to users based on feedback provided in a manner further described below. The system 100 may further include a second user interface associated with the computing network 110 by which host computing devices 150 may access or otherwise exchange communications with the computing network 110. The aforementioned components may be connected or otherwise functionally linked via a communications network which in various embodiments may include, in whole or in part, the Internet, a public network, a private network, or any other communications medium capable of conveying electronic communications.

Generally stated, various operations, steps or algorithms as described in connection with the system 100 or a method 200 as further described below can be embodied directly in hardware, in computer program products such as software module executed by one or more processors 112, or in a combination of the two. The computer program products can reside in RAM memory, flash memory, ROM memory, EPROM memory, EEPROM memory, registers, hard disk, a removable disk, or any other form of computer-readable medium 114 known in the art. An exemplary computer-readable medium 114 can be coupled to the processor 112 such that the processor can read information from, and write information to, the memory/storage medium. In the alternative, the medium 114 can be integral to the processor 112. The processor 112 and the medium 114 can reside in an application specific integrated circuit (ASIC). The ASIC can reside in a user terminal. In the alternative, the processor 112 and the medium 114 can reside as discrete components in a user terminal.

The data storage 114, which may include a database service, cloud databases, or the like, in an embodiment as shown in FIG. 1 may have stored thereon a campaign module 116 for, e.g., initiation of model development campaigns and storing parameters therefor, message responses 118 received as inputs from the feedback devices 130, tagged images 120 from the input messages 118, a first data set 122 built at least in part from the tagged images 120, and a second data set 124 built at least in part from the campaign parameters.

In various embodiments, the computing network 110 may comprise a cloud server, and may in some implementations be part of a cloud application wherein various functions as disclosed herein are distributed in nature between the computing network 110 and other devices 130, 150. Any or all of the feedback devices 130 and host devices 150 may be implemented as at least one of an onboard vehicle controller, a server device, a desktop computer, a laptop computer, a smart phone, or any other electronic device capable of executing instructions. A processor (such as a microprocessor) of the devices 130, 150 may be a generic hardware processor, a special-purpose hardware processor, or a combination thereof.

The feedback devices 130 as shown in FIG. 1 each may further include an interface 132 having a display unit, e.g., for exchanging messages with the computing network 110, and an imaging device 134 such as a camera for capturing images within a field of view. Messages including a content request received from the computing network 110 in the context of a campaign may further include a link or otherwise establish a specific feedback connection 140 in association with a response to the request, wherein the computing network 110 is capable of automatically tagging the image content with metadata associated with the request, the particular feedback device 130, or the like.

As noted above, the imaging devices 134 may typically be cameras which capture still images but may otherwise include video cameras configured to record an original image stream and transmit corresponding data to the computing network 110. In the alternative or in addition, an imaging device 134 within the scope of the present disclosure may include one or more of a digital (CCD/CMOS) camera, an infrared camera, a stereoscopic camera, a PMD camera, high resolution light detection and ranging (LiDAR) scanners, radar detectors, laser scanners, and the like, provided that the resulting output is capable of being processed by the computing network 110 and more particularly any associated modules for model development. Certain image data processing functions may for example be performed discretely at a properly configured imaging device 134 or an associated processor local to the respective feedback device 130, wherein such image data processing is not necessarily performed by the computing network 110 or other downstream image processing unit. In an embodiment, and as further described below, the type of imaging device 134 and/or local image processing capabilities for a respective feedback device 130 may be considered by the system 100 in accordance with a step of potential feedback source device selection.

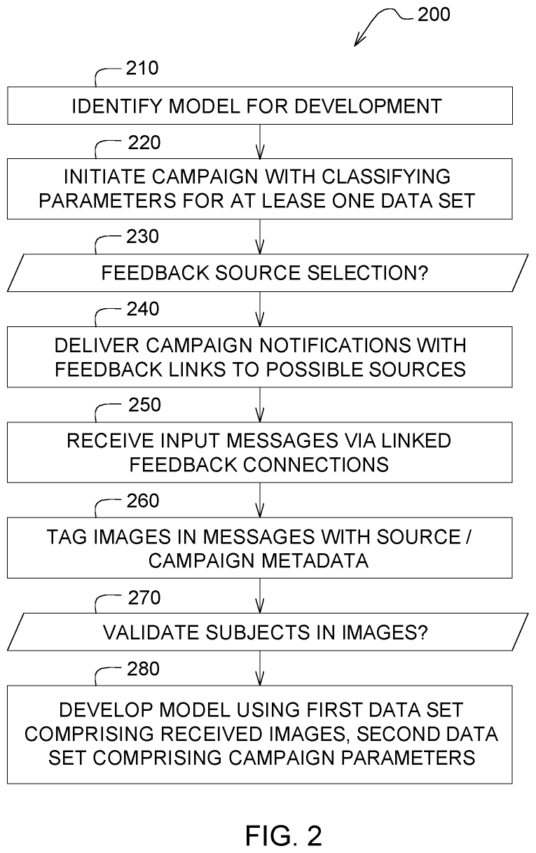

Referring next to FIG. 2, an embodiment of a method 200 may now be described which is exemplary but not limiting on the scope the present disclosure unless otherwise specifically noted. One of skill in the art may appreciate that alternative embodiments may include fewer or additional steps, and that certain disclosed steps may for example be performed in different chronological order or simultaneously.

The method 200 may begin in step 210 with identification of a supervised learning model for development, and further in step 220 (or in various embodiments as part of the same step 210) initiating a campaign for distributed data collection with classifying parameters for at least one data set.

As one illustrative but non-limiting example used in the following description, these initial step(s) may include a determination, based on a specific supervised learning model currently in development, that more images are required specifically including cars in snow, or possibly including equivalent vehicles depending on the application. The system 100 as disclosed herein accordingly may utilize a campaign module 116 to initiate a campaign specifically to collect data from a wide array of potential feedback source devices 130, with such data being tailored as specifically as possible to include cars in an environment where snow is falling or at least present in the image. The campaign module 116 may in various embodiments be developed specifically for a given campaign within the system 100 based on parameters set by a host user, or may be a software product residing in association with the computing network 110 and utilized for selective initiation and/or customization by host users via an interface to the system 100 of each campaign to be generated by the system 100, or may be a module downloaded to the computing network 110 for use with respect to a specific campaign, etc.

In an embodiment, the campaign may involve reviewing any images received from potential feedback source devices 130 by the computing network 110 for relevance to the campaign parameters. Using the above-referenced exemplary campaign parameters, if the system 100 determines that a car may be present in an image, a feedback request 118 may be generated to the source of the image which prompts a respective user to confirm that a car is indeed present in the image. For example, the feedback request 118 may be configured to direct a user interface 132 associated with the respective feedback device 130 to pop up a dialog box with a query such as “Is that a car behind you?” or a multiple choice query such as “What is that behind you?” followed by various user-selectable options including a car. As another example, a feedback request 118 may include the captured image or a virtual rendering thereof on the user interface 132, wherein the user/operator is prompted to identify the desired subject matter within the captured image, for example by clicking on or touching (via a touchscreen) the car within the image. The responses to such feedback requests 118 may be received and processed as further described below to attach relevant metadata to the image which can for example be used later for model development at the cloud server level.

In some embodiments, the campaign may more proactively involve broadcasting of the feedback request 118 including the desired content (e.g., images including cars) and any classifying parameters (e.g., preferably in snow) to substantially all available feedback source devices 130.

While a rewards feature may optionally be included with various embodiments of feedback requests 118 as described within the scope of the present disclosure, such a feature may be of particular relevance for this broadcast type of feedback request 118. For example, the campaign may be broadly directed to any and all potential feedback sources based on a list of the rarest and most valuable data that would desirably be used for model development, but a meaningful volume of such input data may only be forthcoming with the offer of a “data bounty” or the like to feedback sources that actually capture and deliver such data to the system 100. Such a rewards feature may take any of various forms generally known in conventional rewards programs, including but not limited to direct providing of value (monetary or otherwise) to the feedback source.

In various embodiments, the rewards feature may be dynamic in nature to provide rewards to feedback sources that are proportionate or otherwise commensurate with the quality and/or value of the feedback provided. For example, if a broadcast request includes a request for images including any one or more of multiple different subjects, in specific environments which may make individual examples of such data of variable rarity and/or value to the model development, the rewards feature according to the present disclosure may accordingly incorporate such factors into a determination of the appropriate reward, and may specify the variable reward structure as part of the feedback request 118.

In an embodiment, the computing network 110 of the system 100 may include a rewards module or the equivalent (not shown) which collects input data regarding responses from potential feedback source devices 130 as compared to the number of feedback requests 118 sent out, further as correlated to for example the type of rewards feature offered in association with the feedback requests 118. Such an analysis may for example be conducted on a campaign-specific basis or across a plurality of campaigns for the purpose of learning over time which rewards are most likely to produce the highest amount of feedback (in total and/or within a threshold period of time from the initial feedback requests), a highest value or relevance of such feedback, and the like.

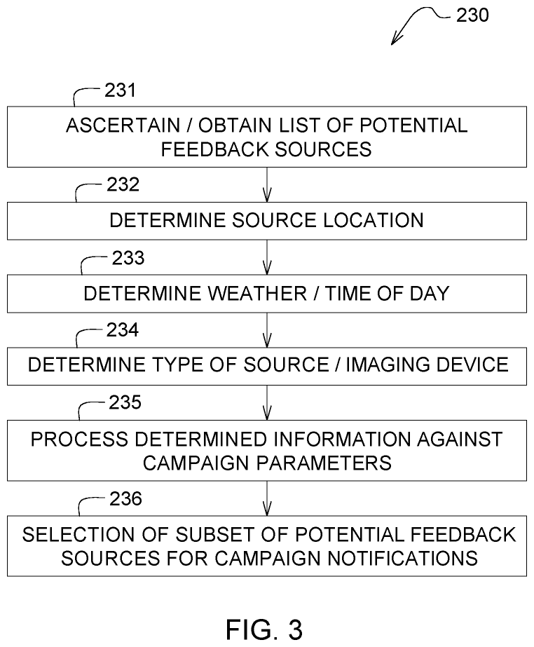

As an alternative to the broadcast embodiment, the method 200 may in some embodiments (as shown in step 230) include feedback source selection to more specifically tailor the feedback requests 118 and increase the reliability and/or value of feedback received in association with the campaign. Referring now to FIG. 3, various exemplary sub-steps according to a feedback source selection step 230 may now be described.

Upon ascertaining or otherwise obtaining a list of potential feedback sources (step 231), which may initially include substantially all feedback devices 130 associated with or even known to the system 100, the system may proceed to filter the list by examining for example, and for each of the potential feedback sources, a determined source location (step 232), a determined weather and/or time of day (step 233), a determined type of feedback device 130 and/or associated imaging device 134 (step 234), and the like. Again using the illustrative but non-limiting example of cars in snow as the campaign parameters, the method 200 may include screening potential feedback source devices 130 for those that are currently present in urban regions having a weather forecast for snow, or possibly including those regions where snow is confirmed to have fallen recently.

Although not shown, the process may include other factors such as a historical response rate of a given potential feedback source, a historical speed and/or efficacy of such responses, etc.

The method 200 may further include processing (step 235) the determined information for each of (or a subset of) the available potential feedback sources with respect to the campaign parameters, and selecting accordingly a group of feedback sources to receive notifications with requests for feedback (step 236).

As a result, an initial array of available feedback source devices 130a, 130b, . . . 130x as shown in FIG. 1 may be filtered substantially using various parameters and corresponding comparisons to a tailored subset thereof.

Returning to FIG. 2, the campaign notifications including feedback requests 118 may then be delivered (step 240) to each of the selected feedback source devices 130, or broadcast to each potential feedback source device 130. The outgoing notification may be in the form of a message including a link to a feedback connection via the communications network, or the system 100 may alternatively establish a respective feedback connection upon a response to the message, wherein the method 200 may continue by receiving input messages (step 250) from the feedback devices 130 via the established feedback connections.

One embodiment of a feedback source device 130 includes cell phones associated with users associated with or otherwise known to the system 100, wherein the feedback request 118 may for example take the form of a message and ask the user to simply reply to the message with an image including the requested subject matter (e.g., cars in snow) attached thereto.

Another embodiment of a feedback source device 130 includes onboard imaging systems 134 associated with a vehicle, for example a work machine. Such a vehicle may include one or more onboard cameras having respective fields of vision directed to surroundings of the vehicle in any of various directions, as for example may be part of an obstacle detection unit for a work machine. The operator of such a vehicle may receive the feedback request 118 via a display unit associated with the user interface 132 in the operator cab of the work machine, wherein for example the operator may be asked as part of the feedback request 118 to simply press a particular joystick button, and/or another user interface tool such as a touchscreen interface, when they see a car in the field of view of the camera (or one of a plurality of available cameras) and further when it is snowing. The operator may be prompted to confirm the subject matter within a captured image that is displayed on an onboard display unit prior to delivery of the response via the feedback connection 140. In an embodiment, the type of operator interaction for image capture and/or subject matter confirmation may be specified by the feedback request 118.

In each of the above-referenced embodiments for feedback source devices 130 (e.g., cell phones, onboard work machine devices), the feedback received via the established connection 140 directly in response to the feedback request 118 may typically be easily associated by the computing network 110 as including or otherwise being provided in association with the campaign parameters and/or certain metadata. Accordingly, upon receiving input messages having images attached, embedded, or otherwise associated therewith, the method 200 may further include (step 260) tagging or otherwise associating the images with metadata corresponding to, e.g., the feedback source, the feedback device, the time and/or date of the image capture, campaign parameters, etc. In an embodiment, the tagged images may be stored as part of a first data set, whereas the metadata and/or campaign parameters may be stored as part of a second data set.

The image and/or metadata may in an embodiment be verified or otherwise validated (step 270) using manual or automatic techniques, for example to confirm in a low-cost manner that the subject(s) in the captured and transmitted images properly correspond to the campaign parameters. Such a step in various embodiments be omitted altogether, where for example the process has been tailored to substantially eliminate uncertainty regarding the subject matter and metadata associated with the images. As one example, such verification may be provided by the user/operator as part of the image capture process and prior to delivery of the input message 120, as noted above. In another embodiment, the campaign module 116 or other module associated with the computing network 110 may be configured to perform an image analysis, for example using conventional image classification techniques, to determine a confidence level regarding the requested subject matter being present in the image. The system 100 may for example elect to disregard any images for which there is less than a threshold level of confidence that the subject matter is present in the respective image, or may alternatively (or in addition) disregard any images for which there is at least a threshold level of confidence that the subject matter is not present in the respective image.

The method 200 may then, or at least upon having received a sufficient amount of data via at least the campaign therefor, continue (step 280) with development of the identified model by, e.g., training the supervised learning classifiers via mapping of the first data set with respect to the second data set. With the respective images in the first data set already having been ‘labeled’ in accordance with the campaign parameters and corresponding metadata, the requirement for additional resources may not be required or at least substantially reduced in order to provide ground truth for this part of the training and testing stage.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A method of expediting distributed feedback for training of supervised learning models, the method comprising:
in association with development of at least a first model for classifying at least a first type of subject, generating notifications to each of a plurality of potential feedback source devices requesting responsive images comprising the least first type of subject;
establishing a respective feedback connection between each of the plurality of potential feedback source devices and a data storage network associated with the at least a first model, and automatically tagging input messages comprising responsive images received via the feedback connection with source metadata and further as being in association with the notification; and
correlating the images received via the respective feedback connections, as components of a first data set for the at least first model, with the at least first type of subject and tagged metadata.

2. The method of claim 1, comprising:
initiating at least a first campaign for development of the at least first model for classifying the at least first type of subject under one or more defined classifying conditions;
wherein the images received via the respective feedback connections in association with the at least first campaign are correlated with the at least first type of subject and tagged source metadata comprising at least one of the one or more defined classifying conditions.

3. The method of claim 2, comprising broadcasting notifications to a network of available feedback source devices comprising each of the plurality of potential feedback source devices, in accordance with the first campaign, wherein the broadcast notifications including a request for images comprising the at least first type of subject under the at least one of the one or more defined classifying conditions.

4. The method of claim 2, comprising selecting each of the plurality of potential feedback source devices from a network of available feedback source devices based on identified lighting and/or weather conditions associated with each of the network of available feedback source devices as corresponding to the at least one of the one or more defined classifying conditions.

5. The method of claim 4, wherein the lighting and/or weather conditions associated with each of the network of available feedback source devices are identified by reference to respective position data with respect to a time of day and/or determined weather conditions.

6. The method of claim 5, wherein the respective weather conditions for each of the network of available feedback source devices are determined via one or more third party weather applications and/or databases.

7. The method of claim 1, comprising automatically verifying images received via the feedback connection as relating to the at least first type of subject, based at least in part on the source metadata and the corresponding notification, and only correlating verified images in the data storage, as components of the first data set for the at least first model, with the at least first type of subject and the tagged metadata.

8. The method of claim 1, wherein the plurality of potential feedback source devices each comprise an onboard display unit, a user interface, and one or more image sensors, and wherein user engagement of at least one specified portion of the user interface responsive to the generated notification causes an image to be captured by at least one of the one or more image sensors and then transmitted via the respective feedback link.

9. The method of claim 8, wherein the tagged source metadata for each image comprises a type of image sensor capturing the image, and/or a location of the feedback source devices, and/or a data and time at which the image is captured.

10. A system of expediting distributed feedback for training of supervised learning models, the system comprising:
a computing network configured, in association with development of at least a first model for classifying at least a first type of subject, to
generate notifications to each of a plurality of potential feedback source devices requesting responsive images comprising the least first type of subject,
establish a respective feedback connection between each of the plurality of potential feedback source devices and a data storage network associated with the at least a first model, and automatically tag images within responsive input messages received via the feedback connection with source metadata and further as being in association with the notification, and
correlate the images received via the respective feedback connections, as components of a first data set for the at least first model, with the at least first type of subject and tagged metadata.

11. The system of claim 10, wherein the plurality of potential feedback source devices each comprise an onboard display unit, a user interface, and one or more image sensors, and wherein user engagement of at least one specified portion of the user interface responsive to the generated notification causes an image to be captured by at least one of the one or more image sensors and then transmitted via the respective feedback link.

12. The system of claim 11, wherein a subset of the plurality of potential feedback source devices comprises one or more work vehicles.

13. The system of claim 11, wherein a subset of the plurality of potential feedback source devices comprises one or more mobile computing devices.

14. The system of claim 11, wherein the tagged source metadata for each image comprises a type of image sensor capturing the image, and/or a location of the feedback source device, and/or a data and time at which the image is captured.

15. The system of claim 10, wherein:
the computing network is configured to initiate at least a first campaign for development of the at least first model for classifying the at least first type of subject under one or more defined classifying conditions; and
the images received via the respective feedback connections in association with the at least first campaign are correlated with the at least first type of subject and tagged source metadata comprising at least one of the one or more defined classifying conditions.

16. The system of claim 15, wherein the computing network is configured to broadcast notifications to a network of available feedback source devices comprising each of the plurality of potential feedback source devices, in accordance with the first campaign, wherein the broadcast notifications include a request for images comprising the at least first type of subject under the at least one of the one or more defined classifying conditions.

17. The system of claim 15, wherein the computing network is configured to select each of the plurality of potential feedback source devices from a network of available feedback source devices based on identified lighting and/or weather conditions associated with each of the network of available feedback source devices as corresponding to the at least one of the one or more defined classifying conditions.

18. The system of claim 17, wherein the lighting and/or weather conditions associated with each of the network of available feedback source devices are identified by reference to respective position data with respect to a time of day and/or determined weather conditions.

19. The system of claim 18, wherein the respective weather conditions for each of the network of available feedback source devices are determined via one or more third party weather applications and/or databases.

20. The system of claim 10, wherein the computing network is configured to automatically verify images received via the feedback connection as relating to the at least first type of subject, based at least in part on the source metadata and the corresponding notification, and only correlate verified images in the data storage, as components of the first data set for the at least first model, with the at least first type of subject and the tagged metadata.
